(19) United States
(12) Patent Application Publication
(10) Pub. No.: US 2021/0296718 A1
(43) Pub. Date: Sep. 23, 2021

(54) Method and Device for Preventing Battery Thermal Runaway, and Battery System

(71) Applicant: Guangzhou Automobile Group Co., Ltd., Guangzhou (CN)

(72) Inventors: Xiaohui LI, Sunnyvale, CA (US); Bozhi YANG, Sunnyvale, CA (US); Meng WANG, Sunnyvale, CA (US)

(21) Appl. No.: 16/823,367

(22) Filed: Mar. 19, 2020

(51) Int. Cl. H01M 10/659; H01M 10/613; H01M 10/0525; H01M 10/651

(52) U.S. Cl. CPC H01M 10/659; H01M 10/651; H01M 10/0525; H01M 10/613

(57) ABSTRACT

A method and device for preventing battery thermal runaway, and a battery system are provided. The method includes: detecting battery thermal runaway happening to at least one battery cell of a battery; and connecting, in response to detecting the battery thermal runaway happening on the at least one battery cell of the battery, the at least one battery cell with an external short circuit through which battery energy of the at least one battery cell is released.

### TECHNICAL FIELD

The present disclosure relates to the field of battery safety, in particular to a method and device for preventing battery thermal runaway, and a battery system.

### BACKGROUND

Nowadays, batteries (e.g., lithium ion batteries) are getting increasingly higher energy density, such as lithium-ion batteries in electric vehicles or electric bikes (e.g., currently used traction lithium-ion batteries for electric vehicles or electric bikes), lithium ion batteries for cell phones, laptop notebooks, portable devices, energy storage stations, power banks, electric robots, etc. However, uncontrollable thermal runaway becomes a challenging issue. Effective methods are needed to address the battery safety (especially thermal runaway) issue.

Common methods to increase battery safety include improved cell chemistry, optimized cell/module pack design, better cooling, accurate prediction of internal shorting (thermal runaway) using big data/AI/physics models, and more advanced control and BMS (battery management system), etc. So far prevention of the battery thermal runaway is very challenging, and effective methods are needed.

### SUMMARY

The following presents a simplified summary in order to provide a basic understanding of some aspects of the present disclosure. This summary is not an extensive overview of the present disclosure. It is intended neither to identify key or critical element of the present disclosure. The following summary merely presents some concepts of the present disclosure in a simplified form as a prelude to the description below.

In accordance with an aspect of the present disclosure, a method for preventing battery thermal runaway is provided. The method for preventing battery thermal runaway includes: detecting battery thermal runaway happening to at least one battery cell of a battery; and connecting, in response to detecting the battery thermal runaway happening on the at least one battery cell of the battery, the at least one battery cell with an external short circuit through which battery energy of the at least one battery cell is released.

In at least one exemplary embodiment of the present disclosure, detecting battery thermal runaway happening to at least one battery cell of a battery includes at least one of: detecting an internal short circuit inside the at least one battery cell; detecting unwanted Lithium plating on an anode of the at least one battery cell; detecting a preset amount of temperature rise within a preset period of time in the at least one battery cell.

In at least one exemplary embodiment of the present disclosure, detecting an internal short circuit inside the at least one battery cell includes: calculating real-time information of every battery cell of the battery, wherein real-time information includes at least one of: partial derivative of voltage and time, internal resistance of real time, phase of internal impedance of real time; and determining, based on the real-time information, whether internal short circuit happens to at least one battery cell among all battery cells of the battery.

In at least one exemplary embodiment of the present disclosure, the external short circuit includes an external resistor.

In at least one exemplary embodiment of the present disclosure, an impedance or electrical resistance of the external short circuit is smaller than an impedance or electrical resistance of an internal short circuit of the battery cell.

In at least one exemplary embodiment of the present disclosure, the impedance or electrical resistance of the external short circuit is fixed; or, the impedance or electrical resistance of the external short circuit is adjusted based on the impedance or electrical resistance of the internal short circuit of the battery cell, or based on an impedance or electrical resistance of an internal circuit of the battery, or based on both the impedance or electrical resistance of the internal short circuit of the battery and the impedance or electrical resistance of the internal circuit of the battery.

In at least one exemplary embodiment of the present disclosure, the method further includes at least one of: dissipating heat generated by the released battery energy at the external short circuit; converting the released battery energy into mechanical energy; converting the released battery energy into chemical energy; saving the released battery energy in a supercapacitor or an inductor.

In at least one exemplary embodiment of the present disclosure, dissipating heat generated by the released battery energy at the external short circuit includes at least one of: connecting the external short circuit with heat sink which absorbs the heat generated by the released battery energy at the external short circuit.

In at least one exemplary embodiment of the present disclosure, converting the released battery energy into mechanical energy includes at least one of: converting the released battery energy into kinetic energy; converting the released battery energy into potential energy.

In at least one exemplary embodiment of the present disclosure, converting the released battery energy into chemical energy includes: conducting an electrolysis process of H2O by the released battery energy.

In accordance with another aspect of the present disclosure, a device for preventing battery thermal runaway is provided. The device for preventing battery thermal runaway includes: an external short circuit provided with pairs of switches that control connection of respective battery cells of a battery to the external short circuit, wherein each pair of the switches cuts off the connection of a battery cell corresponding to the pair of switch to the external short circuit as an initial state, and in response to receiving an activation instruction, switches on the connection of the battery cell corresponding to the pair of switch to the external short circuit through which battery energy of the battery cell corresponding to the pair of switch is released; and a control module, configured to send, in response to being notified of battery thermal runaway happening to at least one battery cell of the battery, an activation instruction to each pair of switch corresponding to the at least one battery cell.

In at least one exemplary embodiment of the present disclosure, the battery thermal runaway happening to at least one battery cell of the battery is caused by at least one of: an internal short circuit inside the at least one battery cell; unwanted Lithium plating on an anode of the at least one battery cell; a preset amount of temperature rise within a preset period of time in the at least one battery cell.

In at least one exemplary embodiment of the present disclosure, an impedance or electrical resistance of the external short circuit is smaller than an impedance or electrical resistance of an internal short circuit of the battery cell.

In at least one exemplary embodiment of the present disclosure, the impedance or electrical resistance of the external short circuit is fixed; or, the impedance or electrical resistance of the external short circuit is adjusted based on the impedance or electrical resistance of the internal short circuit of the battery cell, or based on an impedance or electrical resistance of an internal circuit of the battery, or based on both the impedance or electrical resistance of the internal short circuit of the battery and the impedance or electrical resistance of the internal circuit of the battery.

In at least one exemplary embodiment of the present disclosure, the device further includes at least one of: a heat dissipating module, configured to dissipate heat generated by the released battery energy at the external short circuit; a mechanical energy converting module, configured to convert the released battery energy into mechanical energy; a chemical energy converting module, configured to convert the released battery energy into chemical energy; a electricity saving module, configured to save the released battery energy in a supercapacitor or an inductor.

In at least one exemplary embodiment of the present disclosure, the heat dissipating module includes at least one of: a heat sink which is connected with the external short circuit and absorbs the heat generated by the released battery energy at the external short circuit.

In at least one exemplary embodiment of the present disclosure, the mechanical energy converting module is configured to perform at least one of: converting the released battery energy into kinetic energy; converting the released battery energy into potential energy.

In at least one exemplary embodiment of the present disclosure, the chemical energy converting module is configured to: conduct an electrolysis process of H2O by the released battery energy.

In at least one exemplary embodiment of the present disclosure, the control module is connected with a battery management system (BMS) of the battery, wherein the control module is configured to receive the notification of battery thermal runaway happening to at least one battery cell of the battery from the BMS.

In accordance with still another aspect of the present disclosure, a battery system is provided. The battery system includes: a battery provided with multiple battery cells, and a device for preventing battery thermal runaway, wherein the device for preventing battery thermal runaway includes: an external short circuit provided with pairs of switches that respectively control connection of the multiple battery cells of the battery to the external short circuit, wherein each pair of the switches cuts off the connection of a battery cell corresponding to the pair of switch to the external short circuit as an initial state, and in response to receiving an activation instruction, switches on the connection of the battery cell corresponding to the pair of switch to the external short circuit through which battery energy of the battery cell corresponding to the pair of switch is released; and a control module, configured to send, in response to being notified of battery thermal runaway happening to at least one battery cell of the battery, an activation instruction to each pair of switch corresponding to the at least one battery cell.

In at least one exemplary embodiment of the present disclosure, the battery includes lithium-ion battery.

In at least one exemplary embodiment of the present disclosure, the control module is connected with a battery management system (BMS) of the battery, wherein the control module is configured to receive the notification of battery thermal runaway happening to at least one battery cell of the battery from the BMS.

### BRIEF DESCRIPTION OF THE DRAWINGS

The accompanying drawings described here are used for providing a deeper understanding of the present invention, and constitute a part of the application; schematic embodiments of the present invention and description thereof are used for illustrating the present invention and not intended to form an improper limit to the present invention. In the accompanying drawings:

FIG. 1 shows a flow chart of a method for preventing battery thermal runaway according to an embodiment of the present disclosure;

FIG. 2 shows a schematic diagram of a device for preventing battery thermal runaway according to an embodiment of the present disclosure;

FIG. 3 shows a schematic diagram of a battery system according to an embodiment of the present disclosure;

FIG. 4 shows a flow chart of a control algorithm in which energy of a risky battery is dissipated into an external shorting circuit according to an embodiment of the present disclosure;

FIG. 5(a) shows an example of a normally operated battery according to an embodiment of the present disclosure;

FIG. 5(b) shows an example of a battery with one shorted (or temperature rising) battery cell detected according to an embodiment of the present disclosure;

FIG. 5(c) shows an example of a battery with one shorted (or temperature rising) battery cell completely discharged according to an embodiment of the present disclosure

FIG. 5(d) shows an example of a battery with multiple shorted (or temperature rising) battery cells detected according to an embodiment of the present disclosure;

FIG. 6(a) shows an equivalent circuit of the battery according to the embodiment of the present disclosure;

FIG. 6(b) shows an internal short circuit according to the embodiment of the present disclosure; and

FIG. 6(c) shows external short circuit according to the embodiment of the present disclosure.

### DETAILED DESCRIPTION OF THE EMBODIMENTS

In order to make those skilled in the art understand the solutions of the present invention more clearly, the technical solutions in the embodiments of the present invention are clearly and completely elaborated below in combination with the accompanying drawings. It is apparent that the described embodiments are only a part of the embodiments of the present invention but not all. Based on the embodiments of the present invention, all the other embodiments obtained by those of ordinary skill in the art on the premise of not contributing creative effort belong to the scope of protection of the present invention.

It is to be noted that the terms like “first” and “second” in the specification, the claims and the accompanying drawings of the present invention are used for differentiating the similar objects, but do not have to describe a specific order or a sequence. It should be understood that the objects may be exchanged under appropriate circumstances, so that the embodiments of the present invention described here may be implemented in an order different from that described or shown here. Moreover, the terms like “include” and “have” and any variation of them are intended to cover nonexclusive including; for example, the process, method, system, product or device including a series of steps or units do not have to be limited to those clearly listed steps or units, but may include other steps or units which are not clearly listed or inherent in these process, method, system, product or device.

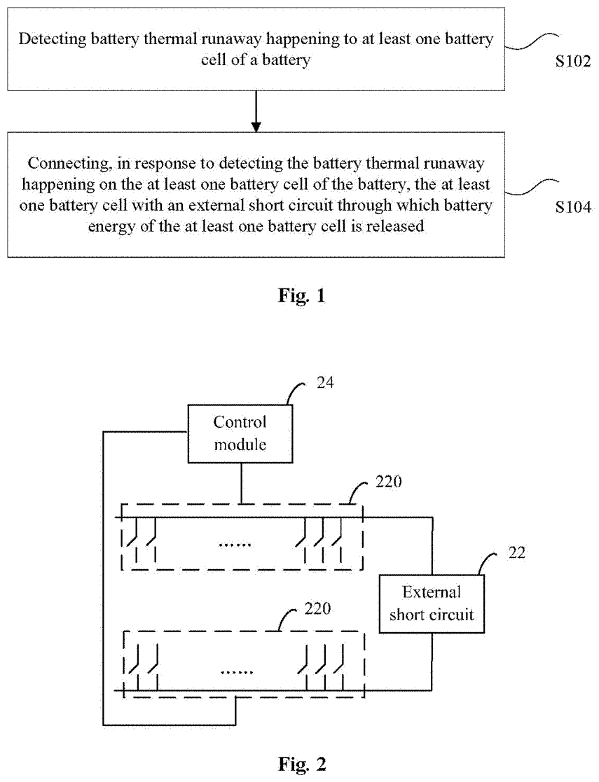

In accordance with an embodiment of the present disclosure, a method for preventing battery thermal runaway is provided. The method may be applied in any type of lithium ion batteries, such as the batteries for cell phone, laptop notebook, portable device, energy storage station, power bank, electric vehicles, electric bikes, electric robots, etc. FIG. 1 shows a flow chart of a method for preventing battery thermal runaway according to an embodiment of the present disclosure. As shown in FIG. 1, the method for preventing battery thermal runaway includes the following operations S102 and S104.

In operation S102, battery thermal runaway happening to at least one battery cell of a battery is detected.

In practical situations, the battery thermal runaway may occur due to mechanical abuse, electric abuse, or thermal abuse. Statistic data show that more than 90% of battery thermal runaway is due to internal short circuit inside a battery cell, which may happen during the entire battery lifetime. In at least one exemplary embodiment of the present disclosure, in order to effectively identify and resolve the battery thermal runaway issue, the operation S102 may include at least one of the following operations.

In operation S102-1, an internal short circuit inside the at least one battery cell is detected. Most (>90%) mechanical, electrical and thermal abuse would cause internal short circuit, and then consequently thermal run away. So if the energy in the battery cell can be removed when internal short circuit is detected, battery thermal runaway should be able to be prevented from happening next. There may be various means for detecting internal short circuit inside the battery cell. In at least one exemplary embodiment of the present disclosure, the operation of detecting an internal short circuit inside the at least one battery cell may include: calculating real-time information of every battery cell of the battery, wherein real-time information includes at least one of: partial derivative of voltage and time, internal resistance of real time, phase of internal impedance of real time; and determining, based on the real-time information, whether internal short circuit happens to at least one battery cell among all battery cells of the battery. There may be other means for detecting internal short circuit inside the battery cell, and the method for preventing battery thermal runaway in the embodiments of the present disclosure has no limitation on the specific methods adopted for detecting the internal short circuit.

In operation S102-2, unwanted Lithium plating on an anode of the at least one battery cell is detected. Unwanted Lithium plating on an anode of the battery cell would sometimes induce internal short circuit and then thermal runaway, or induce a quick temperature rise and then thermal runaway. So if the energy in the battery cell can be removed when unwanted Lithium plating on an anode of the battery cell is detected, battery thermal runaway should be able to be prevented from happening next. There may be various means for detecting the unwanted Lithium plating on the anode of the at least one battery cell.

In operation S102-3, a preset amount of temperature rise within a preset period of time in the at least one battery cell is detected. This operation is to detect a relatively quick temperature rise in the battery cell, which is also a factor causing the battery thermal runaway. So if the energy in the battery cell can be removed when a preset amount of temperature rise within a preset period of time is detected in the at least one battery cell, battery thermal runaway should be able to be prevented from happening next. There may be various means for detecting the quick temperature rise in the at least one battery cell. In at least one exemplary embodiment of the present disclosure, the operation of detecting the quick temperature rise may include: detecting a preset amount of temperature rise within a preset period of time in the at least one battery cell, herein the specific values for the preset amount and the preset period of time may be obtained by experiment or simulation, so that an abnormal temperature rise can be efficiently and properly detected.

In operation S104, in response to detecting the battery thermal runaway happening on the at least one battery cell of the battery, the at least one battery cell is connected with an external short circuit through which battery energy of the at least one battery cell is released.

In some exemplary embodiment of the present disclosure, the external short circuit may include an external resistor. Alternatively, the external short circuit may include other component(s) that can be equivalent to an external resistor. Herein, the term “external” is used to indicate that the resistor is one located outside the battery. Similarly, the term “external short circuit” is used to indicate that the short circuit is formed by connecting the battery cell with components) located outside the battery, and the term “internal short circuit” is used to indicate that the short circuit is formed inside the battery. When detecting the battery thermal runaway happening on the at least one battery cell of the battery, battery energy of the at least one battery cell can be released through an external short circuit formed by connecting the at least one battery cell with the external resistor.

The at least one battery cell is connected with the external short circuit to form a closed loop. In order to enable the external short circuit to discharge a majority of the electric energy of the shorted (or temperature rising) battery cell, that is, to enable the external short circuit to deplete most of the electric energy of the battery cell, in at least one exemplary embodiment of the present disclosure, an impedance or electrical resistance of the external short circuit is smaller than an impedance or electrical resistance of an internal short circuit of the battery cell. During practical application, it is suggested to use an impedance or electrical resistance of the external short circuit much smaller than impedance or electrical resistance of an internal short circuit of the battery cell. Herein, it should be noted that the method can be applied for the prevention of the battery thermal runaway caused by not only the internal short circuit, but also the quick temperature rise. For the case of the battery thermal runaway caused by quick temperature rise, a preset value, which is obtained by simulation or test, may be adopted as the impedance or electrical resistance of the internal short circuit of the battery cell.

In at least one exemplary embodiment of the present disclosure, the impedance or electrical resistance of the external short circuit may be fixed, for example, the preset value mentioned above. In some other exemplary embodiment of the present disclosure, since the internal resistance of battery (Rᵢ) and the resistance of the internal short circuit (R_{isc}) may vary during the discharging process, it is preferable that the impedance or electrical resistance of the external short circuit is adjusted based on the impedance or electrical resistance (R_{isc}) of the internal short circuit of the battery cell, or based on an impedance or electrical resistance (Rᵢ) of an internal circuit of the battery, or based on both the impedance or electrical resistance (R_{isc}) of the internal short circuit of the battery and the impedance or electrical resistance (Rᵢ) of the internal circuit of the battery.

By virtue of the solution in the present embodiment, the battery thermal runaway inside a shorted (or temperature rising) battery cell can be prevented, and the temperature rise due to internal short circuit can be limited to some extent, so that it will not cause large scale short circuit and thermal runaway.

Since a majority of the electric energy of the shorted (or temperature rising) battery cell is depleted through the external short circuit, and this part of electric energy may also result in trouble outside the battery if not dealt with properly, in at least one exemplary embodiment of the present disclosure, the method may further include at least one of the following operations.

Operation 1: heat generated by the released battery energy at the external short circuit is dissipated. There may be many ways applicable to help with the dissipation of the heat generated at the external short circuit. For example, in at least one exemplary embodiment of the present disclosure, dissipating heat generated by the released battery energy at the external short circuit may include: connecting the external short circuit with heat sink which absorbs the heat generated by the released battery energy at the external short circuit. Some examples of such heat sink may include: a water container (in which the external short circuit is to be immersed to dissipate the heat generated by the released battery energy at the external short circuit); the chassis or body of a car (as large thermal mass), phase-change material (large latent heat), or other types of heat absorbing objects. There may be heat sinks in other forms, and the method for preventing battery thermal runaway in the embodiments of the present disclosure has no limitation on the specific form of heat sinks.

Operation 2: the released battery energy is converted into mechanical energy. There may be many ways of converting the released battery energy into the mechanical energy. For example, in at least one exemplary embodiment of the present disclosure, converting the released battery energy into mechanical energy may include at least one of: converting the released battery energy into kinetic energy (in the form of rotating disk); converting the released battery energy into potential energy (in the form of compression springs). The released battery energy may be converted into other forms of mechanical energy, and the method for preventing battery thermal runaway in the embodiments of the present disclosure has no limitation on the specific forms of the mechanical energy.

Operation 3: the released battery energy is converted into chemical energy. There may be many ways of converting the released battery energy into the chemical energy. For example, in at least one exemplary embodiment of the present disclosure, converting the released battery energy into chemical energy may include: conducting an electrolysis process of H2O by the released battery energy. The released battery energy may be converted into other forms of chemical energy, and the method for preventing battery thermal runaway in the embodiments of the present disclosure has no limitation on the specific forms of the chemical energy.

Operation 4: the released battery energy is saved in a supercapacitor or an inductor. Currently moving and storing the battery electricity into super-capacitors or inductors are feasible means to quickly discharge/de-energize the hazardous battery.

According to the method described in the embodiments, the battery energy is released quickly to an external energy sink, after a battery thermal runaway warning is detected. Once an internal circuit shorting (or quick temperature rise) of one battery cell is detected and verified, an external electric short circuit is activated with the shorted (or temperature rising) battery. The impedance or electrical resistance of the external short circuit is much smaller than the impedance or electrical resistance of the internal short circuit of the battery cell, so that a majority of stored battery electrical energy is discharged through the external short circuit to the external short circuit. Only a small portion of battery electrical energy is dissipated through internal short circuit, and therefore only a much smaller temperature rise occurs inside the battery cell due to the internal short circuit. The temperature rise due to internal short circuit is limited to some extent, so that it will not cause large scale short circuit and thermal runaway.

It is to be noted that for the sake of simple description, each aforementioned embodiment of the method is described as a series of action combinations. But those skilled in the art should know that the present invention is not limited to a sequence of the described actions, it is because some steps may be performed in other sequences or simultaneously according to the present invention. Besides, those skilled in the art should also know that all the embodiments described in the specification are preferred embodiments, and the actions and modules involved may not be necessary.

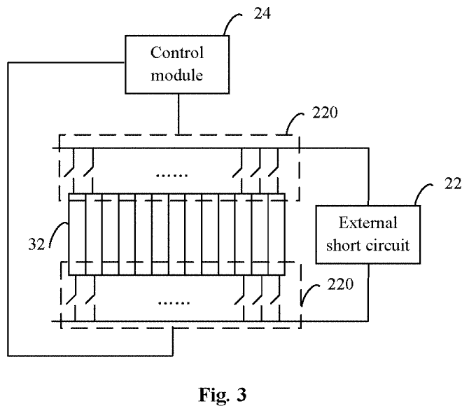

In accordance with another embodiment of the present disclosure, a device for preventing battery thermal runaway is provided. The device for preventing battery thermal runaway may be installed in any terminal or equipment or vehicle with lithium ion batteries, such as cell phone, laptop notebook, portable device, energy storage station, power bank, electric vehicles, electric bikes, electric robots, etc. FIG. 2 shows a schematic diagram of a device for preventing battery thermal runaway according to an embodiment of the present disclosure. As shown in FIG. 2, the device for preventing battery thermal runaway includes:

an external short circuit 22 provided with switches 220 that control connection of respective battery cells of a battery to the external short circuit 22, wherein each of the switches 220 cuts off the connection of a battery cell corresponding to the switch 220 to the external short circuit 22 as an initial state, and in response to receiving an activation instruction, switches on the connection of the battery cell corresponding to the switch 220 to the external short circuit 22 through which battery energy of the battery cell corresponding to the switch 220 is released; and

a control module 24, configured to send, in response to being notified of battery thermal runaway happening to at least one battery cell of the battery, an activation instruction to each pair of switch 220 corresponding to the at least one battery cell.

In practical situations, the battery thermal runaway may occur due to mechanical abuse, electric abuse, or thermal abuse. Statistic data show that more than 90% of battery thermal runaway is due to internal short circuit inside a battery cell, which may happen during the entire battery lifetime. In at least one exemplary embodiment of the present disclosure, the battery thermal runaway happening to at least one battery cell of the battery may be caused by at least one of:

(1) An internal short circuit inside the at least one battery cell.

(2) Unwanted Lithium plating on an anode of the at least one battery cell.

(3) A preset amount of temperature rise within a preset period of time in the at least one battery cell.

In some exemplary embodiment of the present disclosure, the external short circuit 22 may include an external resistor. Alternatively, the external short circuit 22 may include other component(s) that can be equivalent to an external resistor. Herein, the term “external resistor” is used to indicate that the resistor is one located outside the battery. Similarly, the term “external short circuit” is used to indicate that the short circuit is formed by connecting the battery cell with component(s) located outside the battery, and the term “internal short circuit” is used to indicate that the short circuit is formed inside the battery.

In order to enable the external short circuit 22 to discharge a majority of the electric energy of the shorted (or temperature rising) battery cell, that is, to enable the external short circuit to deplete most of the electric energy of the battery cell, in at least one exemplary embodiment of the present disclosure, an impedance or electrical resistance of the external short circuit 22 is smaller than an impedance or electrical resistance of an internal short circuit of the battery cell. During practical application, it is suggested to use an impedance or electrical resistance of the external short circuit 22 much smaller than and impedance or electrical resistance of an internal short circuit of the battery cell. Herein, it should be noted that the device can be applied for the prevention of the battery thermal runaway caused by not only the internal short circuit, but also the quick temperature rise. For the case of the battery thermal runaway caused by quick temperature rise, a preset value, which is obtained by simulation or test, may be adopted as the impedance or electrical resistance of the internal short circuit of the battery cell.

In at least one exemplary embodiment of the present disclosure, the impedance or electrical resistance of the external short circuit 22 may be fixed, for example, the preset value mentioned above. In some other exemplary embodiment of the present disclosure, since the internal resistance of battery (Rᵢ) and the resistance of the internal short circuit (R_{isc}) may vary during the discharging process, it is preferable that the impedance or electrical resistance of the external short circuit 22 is adjusted based on the impedance or electrical resistance (R_{isc}) of the internal short circuit of the battery cell, or based on an impedance or electrical resistance (Rᵢ) of an internal circuit of the battery, or based on both the impedance or electrical resistance (R_{isc}) of the internal short circuit of the battery and the impedance or electrical resistance (Rᵢ) of the internal circuit of the battery.

By virtue of the solution in the present embodiment, the battery thermal runaway inside a shorted (or temperature rising) battery cell can be prevented, and the temperature rise due to internal short circuit can be limited to a extent, so that it will not cause large scale short circuit and thermal runaway.

Since a majority of the electric energy of the shorted (or temperature rising) battery cell is depleted through the external short circuit, and this part of electric energy may also result in trouble outside the battery if not dealt with properly, in at least one exemplary embodiment of the present disclosure, the device may further include at least one of the following modules.

(1) A heat dissipating module, configured to dissipate heat generated by the released battery energy at the external short circuit 22. There may be many ways applicable to help with the dissipation of the heat generated at the external short circuit 22. For example, in at least one exemplary embodiment of the present disclosure, the heat dissipating module may include: a heat sink which is connected with the external short circuit 22 and absorbs the heat generated by the released battery energy at the external short circuit 22. Some examples of such heat sink may include: a water container (in which the external short circuit is to be immersed to dissipate the heat generated by the released battery energy at the external short circuit); the chassis or body of a car (as large thermal mass), phase-change material (large latent heat), or other types of heat absorbing objects. There may be heat sinks in other forms, and the device for preventing battery thermal runaway in the embodiments of the present disclosure has no limitation on the specific form of heat sinks.

(2) A mechanical energy converting module, configured to convert the released battery energy into mechanical energy. There may be many ways of converting the released battery energy into the mechanical energy. For example, in at least one exemplary embodiment of the present disclosure, the mechanical energy converting module is configured to perform at least one of: converting the released battery energy into kinetic energy (in the form of rotating disk); converting the released battery energy into potential energy (in the form of compression springs). The released battery energy may be converted into other forms of mechanical energy, and the device for preventing battery thermal runaway in the embodiments of the present disclosure has no limitation on the specific forms of the mechanical energy.

(3) A chemical energy converting module, configured to convert the released battery energy into chemical energy. There may be many ways of converting the released battery energy into the chemical energy. For example, in at least one exemplary embodiment of the present disclosure, the chemical energy converting module is configured to: conducting an electrolysis process of H2O by the released battery energy. The released battery energy may be converted into other forms of chemical energy, and the device for preventing battery thermal runaway in the embodiments of the present disclosure has no limitation on the specific forms of the chemical energy.

(4) An electricity saving module, configured to save the released battery energy in a supercapacitor or an inductor. Currently moving and storing the battery electricity into super-capacitors or inductors are feasible means to quickly discharge/de-energize the hazardous battery.

In at least one exemplary embodiment of the present disclosure, the control module 24 may be connected with a battery management system (BMS) of the battery, wherein the control module 24 may be configured to receive the notification of battery thermal runaway happening to at least one battery cell of the battery from the BMS.

According to the device described in the embodiments, the battery energy is released quickly to an external energy sink, after a battery thermal runaway warning is detected. Once an internal circuit shorting (or quick temperature rise) of one battery cell is detected and verified, an external electric short circuit is activated with the shorted (or temperature rising) battery. The impedance or electrical resistance of the external short circuit is much smaller than the impedance or electrical resistance of the internal short circuit of the battery cell, so that a majority of stored battery electrical energy is discharged through the external short circuit to the external resistor. Only a small portion of battery electrical energy is dissipated through internal short circuit, and therefore only a much smaller temperature rise occurs inside the battery cell due to the internal short circuit. The temperature rise due to internal short circuit is limited to some extent, so that it will not cause large scale short circuit and thermal runaway.

The modules described as separate parts may be or may not be separate physically. The part shown as the module may be or may not be a physical module, that is to say, it may be in a place or distributed on multiple network modules. It is possible to select, according to the actual needs, part or all of the modules to achieve the objective of the solutions in the present invention.

Moreover, all the function modules in the embodiments of the present invention may be integrated in a processing module; or the modules exist separately and physically; or two or more than two modules are integrated in a module. The integrated module may be realized in form of hardware or in form of software function module.

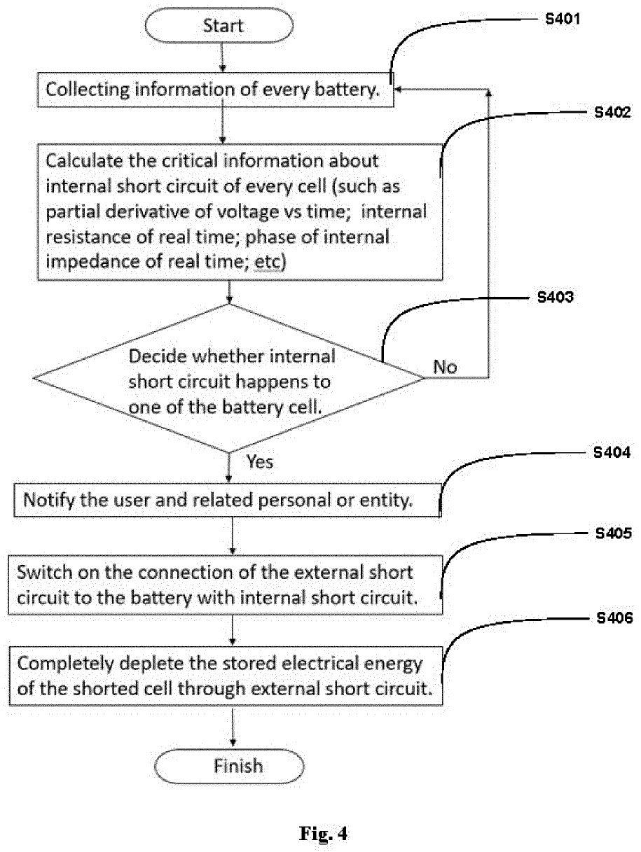

In accordance with still another embodiment of the present disclosure, a battery system is provided. The battery system may be applied in any terminal or equipment or vehicle with lithium ion batteries, such as cell phone, laptop notebook, portable device, energy storage station, power bank, electric vehicles, electric bikes, electric robots, etc. FIG. 3 shows a schematic diagram of a battery system according to an embodiment of the present disclosure. As shown in FIG. 3, the battery system may include:

a battery 32 provided with multiple battery cells, and

a device 34 for preventing battery thermal runaway, wherein the device 34 for preventing battery thermal runaway includes: an external short circuit 22 provided with switches 220 that respectively control connection of the multiple battery cells of the battery 32 to the external short circuit 22, wherein each of the switches 220 cuts off the connection of a battery cell corresponding to the switch 220 to the external short circuit 22 as an initial state, and in response to receiving an activation instruction, switches on the connection of the battery cell corresponding to the switch 220 to the external short circuit 22 through which battery energy of the battery cell corresponding to the switch 220 is released; and a control module 24, configured to send, in response to being notified of battery thermal runaway happening to at least one battery cell of the battery 32, an activation instruction to each pair of switch 220 corresponding to the at least one battery cell.

Other aspects of the device 34 for preventing battery thermal runaway can be obtained based on description in the previous embodiments, and thus will not be repeated herein.

In at least one exemplary embodiment of the present disclosure, the battery 32 includes lithium-ion battery.

In at least one exemplary embodiment of the present disclosure, the control module 24 may be connected with a battery management system (BMS) of the battery 32, wherein the control module 24 may be configured to receive the notification of battery thermal runaway happening to at least one battery cell of the battery from the BMS.

According to the battery system described in the embodiments, the battery energy is released quickly to an external energy sink, after a battery thermal runaway warning is detected. Once an internal circuit shorting (or quick temperature rise) of one battery cell is detected and verified, an external electric short circuit is activated with the shorted (or temperature rising) battery. The impedance or electrical resistance of the external short circuit is much smaller than the impedance or electrical resistance of the internal short circuit of the battery cell, so that a majority of stored battery electrical energy is discharged through the external short circuit to the external resistor. Only a small portion of battery electrical energy is dissipated through internal short circuit, and therefore only a much smaller temperature rise occurs inside the battery cell due to the internal short circuit. The temperature rise due to internal short circuit is limited to some extent, so that it will not cause large scale short circuit and thermal runaway.

The modules described as separate parts may be or may not be separate physically. The part shown as the module may be or may not be a physical module, that is to say, it may be in a place or distributed on multiple network modules. It is possible to select, according to the actual needs, part or all of the modules to achieve the objective of the solutions in the present invention.

Moreover, all the function modules in the embodiments of the present invention may be integrated in a processing module; or the modules exist separately and physically; or two or more than two modules are integrated in a module. The integrated module may be realized in form of hardware or in form of software function module.

According to still another embodiment of the present disclosure, a detailed method for preventing battery thermal runaway is described.

The key idea of the method for preventing battery thermal runaway is to release battery energy quickly to an external energy sink, after a battery thermal runaway warning is detected. Once an internal circuit shorting (or quick temperature rise) of one battery cell is detected and verified, an external electric short circuit is activated with the shorted (or temperature rising) battery. The impedance or electrical resistance of the external short circuit is much smaller than the impedance or electrical resistance of the internal short circuit of the battery. Therefore, majority of stored battery electrical energy is discharged through the external short circuit to the external resistor. Only a small portion of battery electrical energy is dissipated through internal short circuit, and therefore only a much smaller temperature rise occurs inside the battery cell due to the internal short circuit. The temperature rise due to internal short circuit is limited to some extent, so that it will not cause large scale short circuit and thermal runaway.

The external short circuit could work as a heater immersed in a water container or connected with some energy sink which quickly absorbs the heat generated in the external short circuit. Heat sink can also be the chassis or body of a car (as large thermal mass), phase-change material (large latent heat), or other types of heat absorbing objects. It is also possible that heat is dissipated to multiple types of heat sinks mentioned above (not limited to them).

In addition to dissipating into heat, it is also possible to convert or save the electric energy in the battery to other forms of energy, e.g., mechanical energy, chemical energy, or save it to some sort of inductor or super capacitor. The form of the stored mechanical energy can be kinetic energy in the form of rotating disk, or potential energy such as compression springs. Chemical energy may be electrolysis of H2O or others. Supercapacitor or inductors are also likely, since they are solid state with high energy density. Even with the state-of-the-art technology, supercapacitors or inductors still have relative higher-cost and self-discharge problem, but these limitations may be big issue to store the energy for just a couple of battery cells before they have large scale internal short circuit and thermal runaway.

Although wasted, the electricity in the battery is relatively low-cost. Currently we believe that (1) dissipating the electricity in the battery into external heat or (2) Move and store the battery electricity into super-capacitors are relatively more feasible methods than others to quickly discharge/de-energize the hazardous battery. In addition, we believe the above schemes (converting/storing battery electricity into thermal, mechanical, chemical, electric energy, etc.) may be combined so that one or multiple schemes are used in a vehicle.

The concept may be applied to other types of lithium ion battery for other applications, such as cell phone, laptop notebook, portable device, energy storage station, power bank, electric vehicles, electric bikes, electric robots, etc.

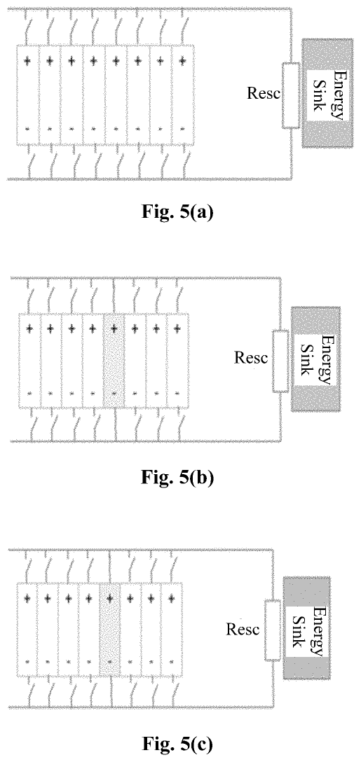

There may be various control algorithms for achieving the method of the embodiment. Below is an example of a possible control algorithm in which energy of a risky battery (with detected early stage internal circuit shorting) is dissipated into an external shorting circuit (e.g., an implementation of the method in a vehicle). FIG. 4 shows a flow chart of a control algorithm in which energy of a risky battery is dissipated into an external shorting circuit according to an embodiment of the present disclosure. As shown in FIG. 4, the control process includes the following operations S401 to S406.

In operation S401, information of every battery is collected.

In operation S402, the critical information about internal short circuit of every cell (such as partial derivative of voltage vs time, internal resistance of real time, phase of internal impedance of real time, etc.) is calculated based on the collected information.

In operation S403, whether internal short circuit (or quick temperature rise) happens to one of the battery cells is detected, if it is detected that internal short circuit happens to any battery cell, the flow proceeds to the operation S404.

In operation S404, the user and related personal or entity are notified of this situation.

In operation S405, the connection of the external short circuit to the battery with internal short circuit is switched on.

In operation S406, the stored electrical energy of the shorted (or temperature rising) cell is completely depleted through external short circuit.

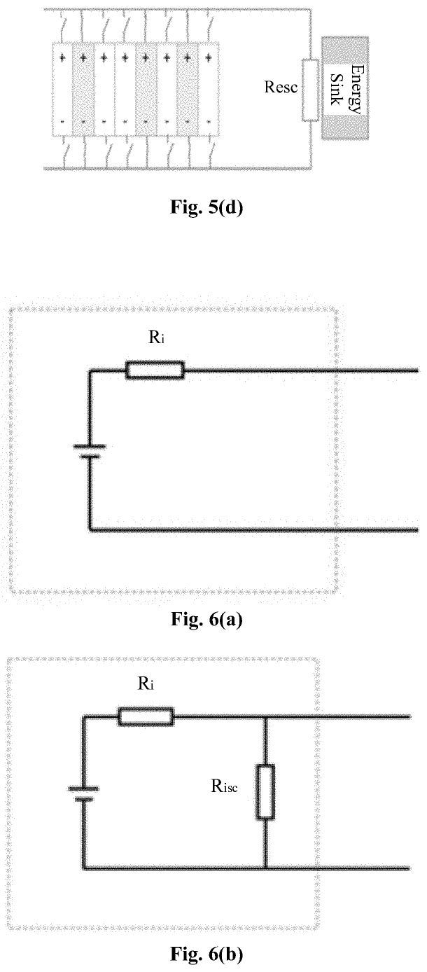

To facilitate the understanding of the method of the embodiment, an implementation example of method, which shows how electric energy of one of more battery cells is dumped to the external heat sink, is shown in FIG. 5. The circuit shown in FIG. 5 (e.g., each battery cell containing two switches) is only to dump or transfer risky battery cell energy to external short circuit, and is not related to the original battery electric connection, which can be connected in series or in parallel to create to desired voltage.

FIG. 5(a) shows an example of a normally operated battery according to an embodiment of the present disclosure. As shown in FIG. 5(a), when there is no detection of internal short circuit in any one of the battery group, the system works in the normal operation mode, and the external short circuit is in open circuit mode.

FIG. 5(b) shows an example of a battery with one shorted (or temperature rising) battery cell detected according to an embodiment of the present disclosure. As shown in FIG. 5(b), when internal short circuit (or quick temperature rise) is detected to happen inside one battery cell (i.e., the fifth cell from the left), the shorted (or temperature rising) cell is connected with the external short circuit (with impedance or resistance being R_{esc}) in a closed loop.

FIG. 5(c) shows an example of a battery with one shorted (or temperature rising) battery cell completely discharged according to an embodiment of the present disclosure. As shown in FIG. 5(c), the electrical energy stored in the shorted (or temperature rising) cell is completely discharged through the external short circuit (with impedance or resistance being R_{esc}), and a majority of the discharged energy is absorbed by the energy sink.

FIG. 5(d) shows an example of a battery with multiple shorted (or temperature rising) battery cells detected according to an embodiment of the present disclosure. As shown in FIG. 5(d), when there is more than one battery cell (the second, fifth and seventh from the left) detected with internal short circuit (or quick temperature rise), all of the shorted (or temperature rising) cells can be connected with the external short circuit and discharged simultaneously.

It should be noted that FIG. 5 shows just one example of implementation, and there can be many other similar variations.

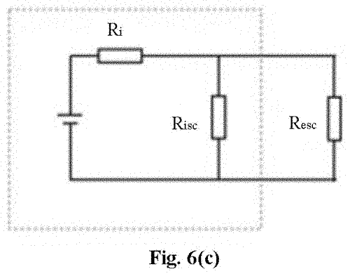

FIG. 6(a) shows an equivalent circuit of the battery according to the embodiment of the present disclosure. FIG. 6(b) shows an internal short circuit according to the embodiment of the present disclosure. FIG. 6(c) shows external short circuit according to the embodiment of the present disclosure. Below is a rough estimation based on the FIG. 6 to show the feasibility of dumping energy to external short circuit.

Assuming that the internal resistance of the battery cell Rᵢ is 0.001Ω, the internal short circuit resistance R_{isc} is 1.0Ω, and the external short circuit resistance R_{esc} is 0.02Ω, then ˜93% of total battery electrical energy will be dissipated to the external resistor R_{esc}. And the remaining 7% energy will be the heat loss for that shorted (or temperature rising) battery.

Take a 21700 battery cell as an example. If the above 7% of total stored energy is used to internally heat up the specific shorted (or temperature rising) cell itself (no heat loss to ambient), we estimated a temperature rise of 76° C. for that specific battery cell. With heat transfer to neighboring cells and also cooling effect from circulating fluid, we estimate the final battery rise can be well controlled below the threshold to avoid the thermal runaway.

Also, if we assume the 93% energy of a 21700 battery cell is used to heat up 0.5 liter water from 25° C. (no heat loss to ambient), we calculated that the final temperature of 0.5 Liter water will reach 58° C. (temperature rise of water is only 33° C.).

The above estimation is for a demonstration of the method only. The actual implementation of the method would take thermal management and cell-to-cell conduction into consideration. We believe the above can largely show the feasibility of the idea.

One more thing to point out is that the resistance of the external short circuit (R_{esc}) can be a fixed value or an adjustable value. Since the internal resistance of battery (Ri) and the resistance of the internal short circuit (R_{isc}) will vary during the discharging process, it is preferable that the value of the external short circuit (R_{esc}) is adjustable during the fast depletion so that the majority (>90%) of stored electrical energy is dissipated to R_{esc} through the external short circuit. This may require more advanced control and higher system complexity.

The above is only the preferred embodiments of the present invention; it should be indicated that, on the premise of not departing from the principles of the present invention, those of ordinary skill in the art may also make a number of improvements and supplements, and these improvements and supplements should fall within the scope of protection of the present invention.

What is claimed is:

1. A method for preventing battery thermal runaway, comprising:
detecting battery thermal runaway happening to at least one battery cell of a battery; and
connecting, in response to detecting the battery thermal runaway happening on the at least one battery cell of the battery, the at least one battery cell with an external short circuit through which battery energy of the at least one battery cell is released.

2. The method as claimed in claim 1, wherein detecting battery thermal runaway happening to at least one battery cell of a battery comprises at least one of:
detecting an internal short circuit inside the at least one battery cell;
detecting unwanted Lithium plating on an anode of the at least one battery cell; and
detecting a preset amount of temperature rise within a preset period of time in the at least one battery cell.

3. The method as claimed in claim 2, wherein detecting an internal short circuit inside the at least one battery cell comprises:
calculating real-time information of every battery cell of the battery, wherein real-time information comprises at least one of: partial derivative of voltage and time, internal resistance of real time, phase of internal impedance of real time; and
determining, based on the real-time information, whether internal short circuit happens to at least one battery cell among all battery cells of the battery.

4. The method as claimed in claim 1, wherein the external short circuit comprises an external resistor.

5. The method as claimed in claim 1, wherein an impedance or electrical resistance of the external short circuit is smaller than an impedance or electrical resistance of an internal short circuit of the battery cell.

6. The method as claimed in claim 5, wherein
the impedance or electrical resistance of the external short circuit is fixed; or,
the impedance or electrical resistance of the external short circuit is adjusted based on the impedance or electrical resistance of the internal short circuit of the battery cell, or based on an impedance or electrical resistance of an internal circuit of the battery, or based on both the impedance or electrical resistance of the internal short circuit of the battery and the impedance or electrical resistance of the internal circuit of the battery.

7. The method as claimed in claim 1, further comprising at least one of:
dissipating heat generated by the released battery energy at the external short circuit;
converting the released battery energy into mechanical energy;
converting the released battery energy into chemical energy;
saving the released battery energy in a supercapacitor or an inductor.

8. The method as claimed in claim 7, wherein dissipating heat generated by the released battery energy at the external short circuit comprises:
connecting the external short circuit with heat sink which absorbs the heat generated by the released battery energy at the external short circuit.

9. The method as claimed in claim 7, wherein converting the released battery energy into mechanical energy comprises at least one of:
converting the released battery energy into kinetic energy;
converting the released battery energy into potential energy.

10. The method as claimed in claim 7, wherein converting the released battery energy into chemical energy comprises:
conducting an electrolysis process of H2O by the released battery energy.

11. A device for preventing battery thermal runaway, comprising:
an external short circuit provided with pairs of switches that control connection of respective battery cells of a battery to the external short circuit, wherein each pair of the switches cuts off the connection of a battery cell corresponding to the pair of switch to the external short circuit as an initial state, and in response to receiving an activation instruction, switches on the connection of the battery cell corresponding to the pair of switch to the external short circuit through which battery energy of the battery cell corresponding to the pair of switch is released; and
a control module, configured to send, in response to being notified of battery thermal runaway happening to at least one battery cell of the battery, an activation instruction to each pair of switch corresponding to the at least one battery cell.

12. The device as claimed in claim 11, the battery thermal runaway happening to at least one battery cell of the battery is caused by at least one of:
an internal short circuit inside the at least one battery cell;
unwanted Lithium plating on an anode of the at least one battery cell; and
a preset amount of temperature rise within a preset period of time in the at least one battery cell.

13. The device as claimed in claim 11, wherein an impedance or electrical resistance of the external short circuit is smaller than an impedance or electrical resistance of an internal short circuit of the battery cell.

14. The device as claimed in claim 13, wherein
the impedance or electrical resistance of the external short circuit is fixed; or,
the impedance or electrical resistance of the external short circuit is adjusted based on the impedance or electrical resistance of the internal short circuit of the battery cell, or based on an impedance or electrical resistance of an internal circuit of the battery, or based on both the impedance or electrical resistance of the internal short circuit of the battery and the impedance or electrical resistance of the internal circuit of the battery.

15. The device as claimed in claim 11, further comprising at least one of:
a heat dissipating module, configured to dissipate heat generated by the released battery energy at the external short circuit;
a mechanical energy converting module, configured to convert the released battery energy into mechanical energy;
a chemical energy converting module, configured to convert the released battery energy into chemical energy;
an electricity saving module, configured to save the released battery energy in a supercapacitor or an inductor.

16. The device as claimed in claim 15, wherein the heat dissipating module comprises:
a heat sink which is connected with the external short circuit and absorbs the heat generated by the released battery energy at the external short circuit.

17. The device as claimed in claim 15, wherein the mechanical energy converting module is configured to perform at least one of:
converting the released battery energy into kinetic energy;
converting the released battery energy into potential energy.

18. The device as claimed in claim 15, wherein the chemical energy converting module is configured to:
conduct an electrolysis process of H2O by the released battery energy.

19. A battery system, comprising: a battery provided with multiple battery cells, and a device for preventing battery thermal runaway, wherein the device for preventing battery thermal runaway comprises:
an external short circuit provided with pairs of switches that respectively control connection of the multiple battery cells of the battery to the external short circuit, wherein each pair of the switches cuts off the connection of a battery cell corresponding to the pair of switch to the external short circuit as an initial state, and in response to receiving an activation instruction, switches on the connection of the battery cell corresponding to the pair of switch to the external short circuit through which battery energy of the battery cell corresponding to the pair of switch is released; and
a control module, configured to send, in response to being notified of battery thermal runaway happening to at least one battery cell of the battery, an activation instruction to each pair of switch corresponding to the at least one battery cell.

20. The battery system as claimed in claim 19, wherein the battery comprises: lithium-ion battery.
